(19) United States
(12) Patent Application Publication
(10) Pub. No.: US 2026/0243798 A1
(43) Pub. Date: Aug. 20, 2026

(54) TECHNIQUES FOR IMPROVING SENSITIVITY OF A LONG RANGE SENSING OF AIR DATA PARAMETERS

(71) Applicant: Honeywell International Inc., Charlotte, NC (US)

(72) Inventors: Kaizhong Gao, North Oaks, MN (US); Thomas Dobbins, Watertown, MN (US); Matthew ArchMiller, Maplewood, MN (US)

(73) Assignee: Honeywell International Inc., Charlotte, NC (US)

(21) Appl. No.: 19/054,638

(22) Filed: Feb. 14, 2025

(51) Int. Cl. G01P 13/02; G01P 5/26; G01S 17/95

(52) U.S. Cl. CPC G01P 13/025; G01P 5/26; G01S 17/95

(57) ABSTRACT

Sensitivity of the OADS is increased by increasing the surface area through which optical energy reflected and/or scattered from a region of atmosphere is collected and analyzed to determine one or more air data parameters. By adding more optical receivers, OADS sensitivity is increased. This technique is less complicated, and thus less expensive, than using two or more optical emitters and two or more optical receivers. Thus, the OADS may be used to more accurately characterize air data parameter(s) of a region of atmosphere of the Earth at altitudes up to more than one hundred thousand feet above the surface of the Earth.

### BACKGROUND

Conventionally, instruments mounted on balloons have been used to characterize air data parameter(s) at high altitudes above the Earth's surface. More recently, high altitude optical air data systems (OADSs) have been used to do the same and do not require the same logistics to launch and recapture balloon borne instruments.

Optical signals received by a high altitude OADS are significantly attenuated when analyzing air data parameters in a region of atmosphere at altitudes, e.g., exceeding thirty kilometers. Such attenuation can cause measurement error(s) in the air data parameter(s).

### SUMMARY

In some aspects, the techniques described herein relate to an optical air data system (OADS) with improved sensitivity, the OADS including: a pulsed laser configured to emit an optical signal including pulses; an optical emitter optically coupled to the pulsed laser, and using the optical signal including pulses, configured to emit only one transmit optical beam along a transmit line of sight to a region of atmosphere; at least two optical receivers, wherein each of the at least two optical receivers is configured to receive a different return optical signal which is a reflected and/or scattered from the region of atmosphere along a unique receive line of sight; a rotatable platform configured to rotate around a first axis and to rotate around a second axis that is orthogonal to the first axis, wherein the optical emitter and each optical receiver are mounted on the rotatable platform, and wherein the rotatable platform is further configured to direct the transmit line of sight to the region of atmosphere; an optical processing circuitry including at least one optical sensor and configured to convert each of at least two return optical signals in to at least one electrical signal representative of at least one characteristic of one or more return optical signals; and electrical processing circuitry configured to receive the at least one electrical signal from the optical processing circuitry and, using the at least one electrical signal, generate at least one air data parameter about the region of atmosphere.

In some aspects, the techniques described herein relate to a method for improving sensitivity of an optical air data system, the method including: orienting a transmit line of sight towards a region of atmosphere; receiving an optical signal including pulses; emitting only one transmit optical beam, including pulses, along the transmit line of sight to the region of atmosphere; receiving at least two different return optical signals, wherein each return optical signal is received along a unique receive line of sight, wherein each return optical signal is derived by scattering and/or reflection, of the only one transmit optical beam, from the region of atmosphere; converting each of the at least two different return optical signals into at least one electrical signal representative of at least one characteristic of one or more return optical signals; and using the at least one electrical signal, generating data about one or more air data parameters about the region of atmosphere.

In some aspects, the techniques described herein relate to an apparatus for improving sensitivity of an optical air data system (OADS), the apparatus including: an optical emitter optically coupled to a pulsed laser, and using an optical signal including pulses, configured to emit only one transmit optical beam along a transmit line of sight to a region of atmosphere; at least two optical receivers, wherein each of the at least two optical receivers is configured to receive a different return optical signal which is a reflected and/or scattered from the region of atmosphere along a unique receive line of sight; wherein the optical emitter and each optical receiver are mounted on a rotatable platform configured to rotate around a first axis and to rotate around a second axis that is orthogonal to the first axis so as to direct the transmit line of sight to the region of atmosphere; an optical processing circuitry including at least one optical sensor and configured to convert each of at least two return optical signals in to at least one electrical signal representative of at least one characteristic of one or more return optical signals; and electrical processing circuitry configured to receive the at least one electrical signal from the optical processing circuitry and, using the at least one electrical signal, generate at least one air data parameter about the region of atmosphere.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1A illustrates a block diagram of one embodiment of an optical air data system implemented according to embodiments of the invention.

FIG. 1B illustrates one embodiment of a surface of a chassis;

FIG. 2A illustrates a diagram of one embodiment of an optical receiver;

FIG. 2B illustrates a diagram of one embodiment of an optical emitter;

FIG. 2C illustrates a diagram of one embodiment of an optical emitter and an optical receiver;

FIG. 3 illustrates a block diagram of one embodiment of an electrooptical processing system.

FIG. 4A illustrates a block diagram of one embodiment of at least one optical processing system;

FIG. 4B illustrates a block diagram of another embodiment of at least one optical processing system;

FIG. 5 illustrates a block diagram of one embodiment of at least one electrical processing system; and

FIG. 6 illustrates a flow diagram of an exemplary method for determining enhancing the signal to noise ratio of an optical air data system.

In accordance with common practice, the various described features are not drawn to scale but are drawn to emphasize specific features relevant to the exemplary embodiments. Reference characters denote like elements throughout figures and text.

### DETAILED DESCRIPTION

In the following detailed description, reference is made to the accompanying drawings that form a part hereof, and in which is shown by way of illustration specific illustrative embodiments. However, it is to be understood that other embodiments may be utilized, and that structural, mechanical, and/or electrical changes may be made. Furthermore, each method presented in the drawing figures and the specification is not to be construed as limiting the order in which the individual steps may be performed. The following detailed description is not to be taken in a limiting sense.

Embodiments of the invention include an OADS including two or more optical receivers. Sensitivity of the OADS is increased by increasing the surface area through which optical energy reflected and/or scattered from a region of atmosphere is collected and analyzed to determine one or more air data parameters. By adding more optical receivers, OADS sensitivity is increased. This technique is less complicated, and thus less expensive, than using two or more optical emitters and two or more optical receivers. Thus, the OADS may be used to more accurately characterize air data parameter(s) of a region of atmosphere of the Earth at altitudes up to more than one hundred thousand feet above the surface of the Earth.

Each optical receiver of the two or more optical receivers has a smaller surface area in comparison to a single optical receiver with a same size surface area as a sum of the smaller surface areas of each of the two or more optical receivers. As a result, optical components in each of the two or more optical receivers are more cost effective and reliable than the optical components of the single optical receiver.

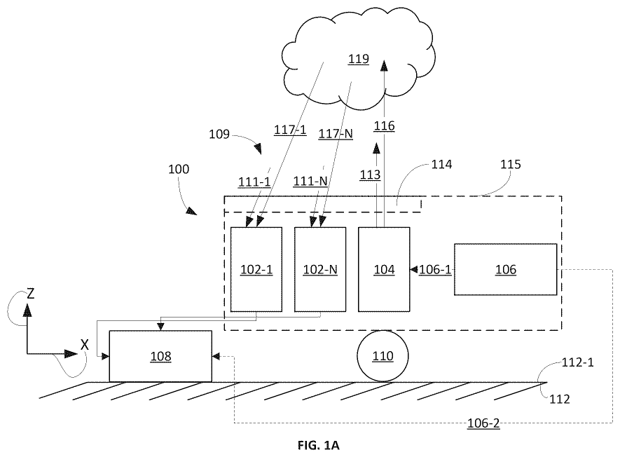

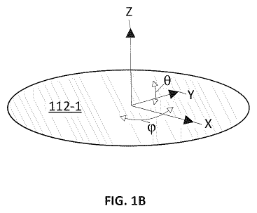

FIG. 1A illustrates a block diagram of one embodiment of an optical air data system (OADS) 100 implemented according to embodiments of the invention. The OADS 100 includes a laser 106, a rotatable platform 110, an optical emitter 104, two or more optical receivers 102-1, 102-N, and an electrooptical processing system (or electrooptical processing circuitry) 108. N is an integer greater than one.

Each of the optical emitter 104 and the two or more optical receivers 102-1, 102-N are mounted on the rotatable platform 110. The rotatable platform 110 is configured to rotate the components mounted on it around at least one axis (e.g., around two orthogonal axes X, Z) with respect to a chassis 112 on which the rotatable platform 110 is mounted. More specifically, the rotatable platform 110 is configured to rotate a transmit line of sight 113 of an optical emitter 104 towards a region of atmosphere 119; as a result, each receive line of sight 111-1, 111-N is directed from the region of atmosphere 119 to a unique optical receiver 102-1, 102-N.

FIG. 1B illustrates one embodiment of a surface 112-1 of a chassis 112. Optionally, the rotatable platform 110 is configured to alter an azimuthal angle φ around the surface 112-1, formed by the x axis X and the y axis Y, and/or an elevation angle θ defined with respect to the surface 112-1 and the z axis Z. The x axis X, y axis Y, and z axis Z are orthogonal to one another. Each of the azimuthal angle φ and the elevation angle θ is of a line of sight, e.g., the transmit line of sight 113 or of a receive line of sight 111-1, 111-N.

Returning to FIG. 1A, the laser 106 is optically coupled to the optical emitter 104. The laser 106 emits a pulsed optical signal (or an optical signal including pulses) 106-1 received by the optical emitter 104. Optionally, a portion 106-2 of the pulsed optical signal is optically coupled to the electrooptical processing system 108 where it may be used to determine air data parameter(s) and/or be utilized for other functions.

Using the pulsed optical signal 106-1, the optical emitter 104 is configured to emit a transmit optical beam 116 along a transmit line of sight (LOS) 113 to a region of atmosphere 119, e.g., of the Earth. The transmit optical beam 116 includes pulses. The region of atmosphere 119 reflects and/or scatters the transmit optical beam 116 into two or more return optical signals 117-1, 117-N. A different, or unique, return optical signal propagates along a unique receive LOS 111-1, 111-N to a unique optical receiver. Thus, each return optical signal 117-1, 117-N is derived by scattering and/or reflection, of the transmit optical beam 116, from the region of atmosphere 119.

The optical receiver 102-1, 102-N is configured to receive the return optical signal 117-1, 117-N from the region of atmosphere 119 external to the optical receiver 102-1, 102-N. Optionally, each optical receiver 102-1, 102-N is configured to optically process, e.g., focus, filter, collimate, and/or reflect, a received return optical signal 117-1, 117-N. Optionally alternatively, such optical processing is performed in the electrooptical processing system 108, e.g., the optical processing system thereof.

Optionally, the optical emitter 104 and each optical receiver 102-1, 102-N are mounted in a package 115 configured to be mounted on the rotatable platform 110. Optionally, at least part of a portion of the package 115 is enclosed by an optical window 114 configured to allow optical propagation of the transmit optical beam 116 and each return optical signal 117-1, 117-N as described elsewhere herein, but to protect the optical emitter 104 and each optical receiver 102-1, 102-N from the environment 109 outside the package 115. Optionally, the laser 106 is mounted in the package 115; however, in other embodiments, the laser 106 may be mounted outside of the package 115.

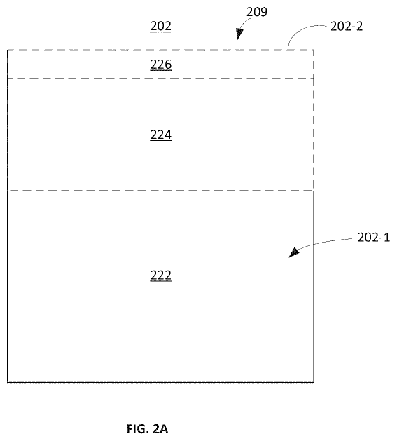

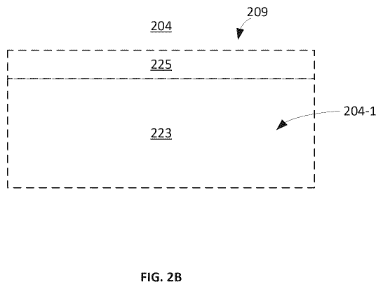

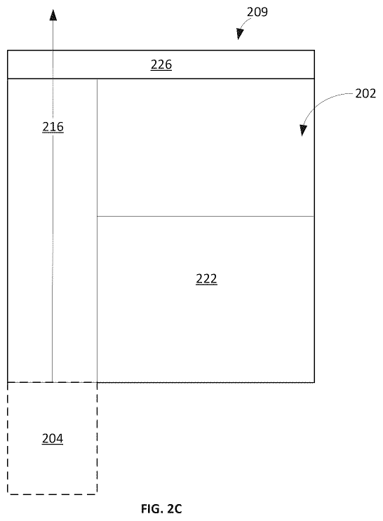

FIG. 2A illustrates a diagram of one embodiment of an optical receiver 202. The exemplary optical receiver 202 includes receive optical waveguide 222, e.g., optical fiber, in which a return optical signal 117-1, 117-N is configured to propagate from the region of atmosphere 119. Optionally, the exemplary optical receiver 202 includes one or more receive optical components 224, e.g., mirror(s) configured to reflect the return optical signal 117-1, 117-N, optical filter(s) configured to optically filter the return optical signal 117-1, 117-N, and/or optical lens(es) configured to focus and/or collimate the return optical signal 117-1, 117-N. Optionally, the exemplary optical receiver 202 includes a receive optical window 226 configured to permit the optical receiver 202 to receive a return optical signal 117-1, 117-N but protect an interior 202-1 of the optical receiver 202 from the environment 209 outside of the optical receiver 202.

The optical receiver 202 includes a cross-section 202-2 through which a return optical signal propagates through the optical receiver 202. Optionally, the cross-section 202-2 is circular, but may be any other planar shape. Returning to FIG. 1A, optionally, the at least two optical receivers 102-1, 102-N includes a first optical receiver including a first optical component including a first optical lens or mirror with a first diameter and a second optical receiver including a second optical component including a second optical lens or mirror with a second diameter. The first diameter is less than the second diameter.

FIG. 2B illustrates a diagram of one embodiment of an optical emitter 204. Optionally, the exemplary optical emitter 204 includes one or more optical components 223, e.g., mirror(s) configured to reflect the transmit optical beam 116, optical filter(s) configured to optically filter the transmit optical beam 116, and/or optical lens(es) configured to focus and/or collimate the transmit optical beam 116. Optionally, the exemplary optical emitter 204 includes a transmit optical window 225 configured to permit the optical emitter 204 to emit the transmit optical beam 116 but protect an interior 204-1 of the optical emitter 204 from the environment 209 outside of the optical emitter 204.

FIG. 2C illustrates a diagram of one embodiment of an optical emitter 204 and an optical receiver 202. In the embodiment illustrated in FIG. 2C, the transmit optical beam 216 is emitted by the optical emitter 204 through a receive optical window 226 of an optical receiver 202, i.e., one of the at least two optical receivers.

Returning to FIG. 1A, each optical receiver 102-1, 102-N is optically coupled, e.g., by optical waveguide (for example optical fiber), to the electrooptical processing system 108. After such processing, each optical receiver 102-1, 102-N optically couples a return optical signal 117-1, 117-N to the electrooptical processing system 108.

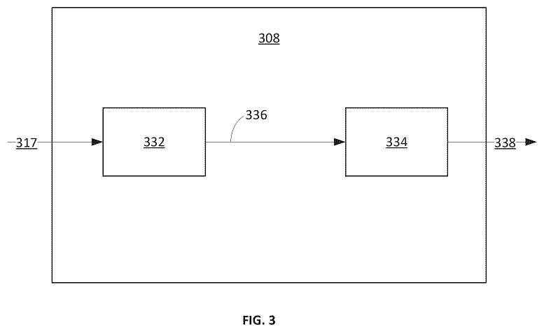

FIG. 3 illustrates a block diagram of one embodiment of an electrooptical processing system 308. The exemplary electrooptical processing system 308 includes an optical processing system 332 electrically coupled to an electrical processing system 334. The optical processing system 332 is configured to receive each return optical signal 317 and to generate an electrical signal 336 representative of at least one characteristic of one or more return optical signals 317. The electrical processing system 334 is configured to transform the electrical signal 336 to data 338 about one or more air parameters of the region of atmosphere from which each return optical signal was scattered and/or reflected. Such air data parameters include without limitation: atmospheric pressure in the region of atmosphere, temperature in the region of atmosphere, humidity in the region of atmosphere, wind speed and/or wind direction in the region of atmosphere, aerosol measurement (e.g., quantifying a presence and characteristics of aerosols) in the region of atmosphere, optical turbulence (e.g., characterizing the effect of fluid motion on light which may occur due to variations in index of refraction) in the region of atmosphere, and/or gas sensing (e.g., detecting and measuring composition and/or concentration of gases) in the region of atmosphere.

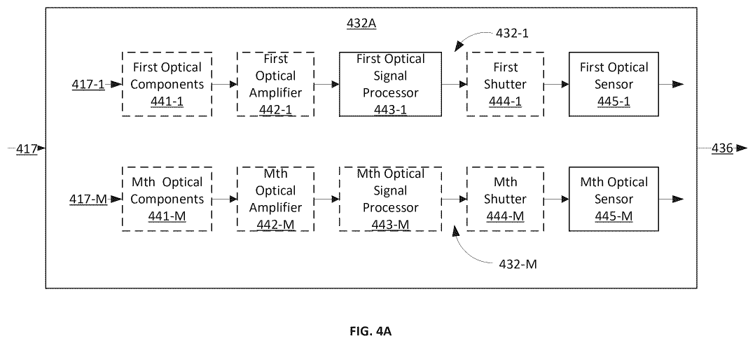

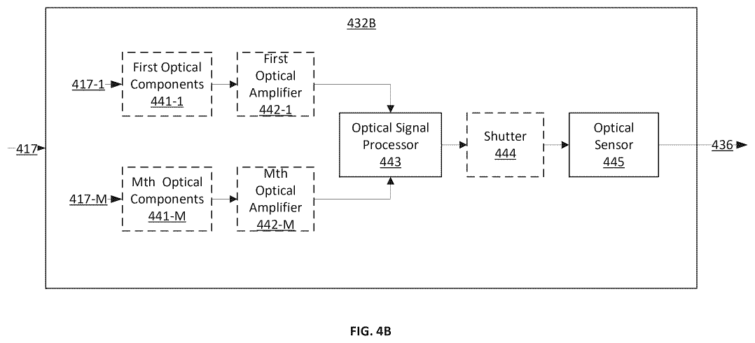

FIG. 4A illustrates a block diagram of one embodiment of at least one optical processing system 432A. The at least one optical processing system 432A includes one or more optical processing subsystem (or one or more optical processing subcircuits) 432-1, 432-M. The at least one optical processing system 432A is configured to receive each return optical signal 417 and to convert each return optical signal 417 to at least one electrical signal 436 representative of at least one characteristic of one or more return optical signals. Each optical processing subsystem 432-1, 432-M is configured to receive at least one of each return optical signal 417-1, 417-M. M is an integer greater than zero. Optionally, M equals N, and each optical processing subsystem 432-1, 432-M is only optically coupled to a unique optical receiver and is configured to only receive at least a part of a return optical signal from that unique optical receiver.

Each optical processing subsystem 432-1, 432-M includes an optical sensor 445-1, 445-M. Each optical sensor 445-1, 445-M is configured to convert each optical signal incident upon the optical sensor into an electrical signal. Optionally, each optical sensor 445-1, 445-M includes a charged coupled device(s) (CCD(s), complementary metal oxide semiconductor (CMOS) sensor(s), and/or photomultiplier tube(s). Each optical sensor 445-1, 445-M may be the same or different from another optical sensor 445-1, 445-M. Optionally, each optical processing subsystem 432-1, 432-M includes a shutter 444-1, 444-M configured to selectively optically shield the optical sensor of the optical subsystem. For example, the shutter 444-1, 444-M may be opened when each optical pulse of one or more return optical signals (or parts thereof) is expected to be received by an optical sensor in the same optical subsystem as the shutter; this technique can be used to improve a sensitivity of the optical subsystem.

Optionally, each optical subsystem includes one or more optical components 441-1, 441-M, an optical amplifier 442-1, 442-M, and/or an optical signal processor (or optical signal processor circuit) 443-1, 443-M. Each optical signal processor 443-1, 443-M may be an optical interferometer (e.g., a Fabry-Perot optical interferometer), optical filter(s), and/or an optical spectrograph. For example, each interferometer is configured to generate an interference pattern using each return optical signal (or part thereof) received by the interferometer.

Each of the optical signal processors 443-1, 443-M may be the same or different from another optical signal processor.

Each of the one or more optional optical components 441-1, 441-M includes optical filter(s) configured to optically filter, e.g., each of, the return optical signal(s), optical waveguide, and/or optical lens(es) configured to focus and/or collimate, e.g., each of, the return optical signal(s). Optionally, each component of such one or more optical components 441-1, 441-M is in lieu of or in addition to the optional one or more optical components 224 described with respect to FIG. 2A. Each optional optical amplifier 442-1, 442-M is configured to amplify each return optical signal (or part thereof) received by the optical subsystem.

FIG. 4B illustrates a block diagram of another embodiment of at least one optical processing system 432B. FIG. 4B is similar to the embodiment illustrated in FIG. 4A except that it includes only one optical signal processor 443, only one optical sensor 445, and optionally only one shutter 444. Each return optical signal 417-1, 417-M is received by the optical signal processor 443 directly or after processing by optional optical components 441-1, 441-M and/or optional optical amplifiers 442-1, 442-M.

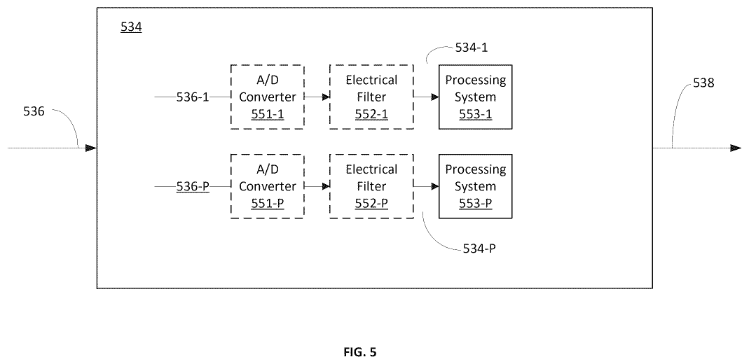

FIG. 5 illustrates a block diagram of one embodiment of at least one electrical processing system 534. The at least one electrical processing system 534 includes one or more electrical processing subsystems (or one or more electrical processing subcircuits) 534-1, 534-P. Each electrical processing subsystem 534-1, 534-P includes a processing system (or processing circuit) 553-1, 553-P. Optionally, each electrical processing subsystem 553-1, 553-P is implemented with at least one processor circuit communicatively coupled to at least one memory circuit. Optionally, the at least one electrical processing system 534 is implemented with at least one digital signal processor.

The electrical processing system 534 is configured to receive at least one electrical signal 536 representative of at least one characteristic of one or more return optical signals. Using the at least one electrical signal 536, the electrical processing system 534 is further configured to generate data 538 about one or more air data parameters about the region of atmosphere from which each return optical signal was scattered and/or reflected.

Each electrical processing subsystem 534-1, 534-P is electrically coupled to one or more optical processing subsystems and is configured to receive an electrical signal 536-1, 536-P representative of at least one characteristic of one or more return optical signals received by such one or more optical processing subsystems. P is an integer greater than zero. Optionally, P equals M; thus, each electrical processing subsystem 534-1, 534-P is only electrically coupled to a unique optical processing subsystem and is configured to only receive an electrical signal 536-1, 536-P representative of at least one characteristic of one or more return optical signals. Optionally, each of P and M equal N; thus, each electrical processing subsystem 534-1, 534-P is only electrically coupled to a unique optical processing subsystem and is configured to only receive an electrical signal 536-1, 536-P representative of at least one characteristic of one or more return optical signals.

Optionally, each electrical processing subsystem 534-1, 534-P includes an analog to digital (A/D) converter 551-1, 551-P and/or an electrical filter 552-1, 552-P. Each A/D converter 551-1, 551-P is configured to convert electrical signal(s) 536-1, 536-P received from one or more optical subsystem(s) from an analog format to a digital format. Each electrical filter 552-1, 552-P is configured to electrically filter electrical signal(s) 536-1, 536-P, e.g., of undesired noise, received from one or more optical subsystems.

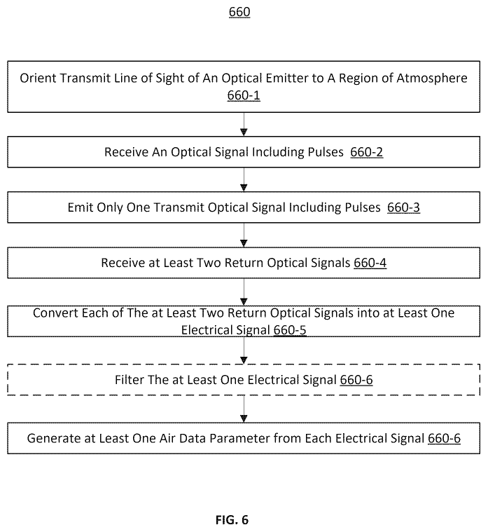

FIG. 6 illustrates a flow diagram of an exemplary method 660 for determining enhancing the signal to noise ratio of an optical air data system. Method 660 is illustrated for pedagogical purposes with a pulsed optical signal. However, the same techniques may be used for a continuous wave optical signal.

Exemplary method 660 may be implemented by one or more of the apparatuses illustrated in FIGS. 1A-5. To the extent the methods herein are described herein as being implemented with one or more of the apparatuses illustrated in FIGS. 1A-5, it is to be understood that other embodiments can be implemented in other ways. Techniques described with respect to the embodiments illustrated by FIGS. 1A-5 may be applicable to the method 660.

The blocks of the flow diagrams herein have been arranged in a generally sequential manner for ease of explanation; however, it is to be understood that this arrangement is merely exemplary, and it should be recognized that the processing associated with the methods (and the blocks shown in the Figures) can occur in a different order (for example, where at least some of the processing associated with the blocks is performed in parallel and/or in an event-driven manner). Optionally, the following blocks are performed during the fourth time period.

In block 660-1, a transmit line of sight (for example, of an optical emitter) is oriented, e.g., with a rotatable platform, towards a region of atmosphere. As a result, optionally, each receive line of sight is directed from the region of atmosphere to a unique optical receiver.

In block 660-2, an optical signal including pulses is received, e.g., at the optical emitter from a laser. In block 660-3, only one optical signal (or transmit optical signal), including pulses, is emitted (e.g., from the optical emitter) along the transmit line of sight to the region of atmosphere.

In block 660-4, at least two different return optical signals are received. Each return optical signal is received along a unique receive line of sight, e.g., by a unique optical receiver. Each return optical signal is derived by scattering and/or reflection, of the transmit optical beam, from the region of atmosphere. Optionally, each return optical signal is further reflected, optically filtered, collimated and/or focused.

In block 660-5, each of the at least two return optical signals is converted, e.g., by an electrooptical processing system (for example, an optical processing system), into at least one electrical signal representative of at least one characteristic of one or more return optical signals. In optional block 660-6, the at least one electrical signal is filtered, e.g., by an electrical filter and of undesired noise.

In block 660-6, using the at least one electrical signal, data about one or more air data parameters (about the region of atmosphere from which each return optical signal was scattered and/or reflected) is generated, e.g., with the electrooptical processing system (for example, the electrical processing system). Optionally, a velocity of an atmospheric region can be determined by calculating a Doppler shift of a carrier frequency of a transmitted optical beam and a carrier frequency of a return optical signal derived from the transmitted optical beam. Other air data parameters, e.g., temperature and humidity, can be determined by other techniques.

While the present teachings have been illustrated with respect to one or more implementations, alterations and/or modifications can be made to the illustrated examples without departing from the scope of the appended claims. In addition, while a particular feature of the present disclosure may have been described with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and/or the claims, such terms are intended to be inclusive in a manner similar to the term “comprising.” The term “at least one of” is used to mean one or more of the listed items can be selected. As used herein, the term “one or more of” with respect to a listing of items such as, for example, A and B or A and/or B, means A alone, B alone, or A and B. The term “at least one of” is used to mean one or more of the listed items can be selected.

Terms of relative position as used in this application are defined based on a plane parallel to the conventional plane or working surface of a material (e.g., a layer or a substrate), regardless of orientation. Terms such as “on,” “higher,” “lower,” “over,” “top,” and “under” are defined with respect to the conventional plane or working surface being on the top surface of a layer or substrate, regardless of orientation. The terms “about” or “substantially” indicate that the value or parameter specified may be somewhat altered, as long as the alteration does not result in nonconformance of the process or structure to the illustrated embodiment. Finally, “exemplary” indicates the description is used as an example, rather than implying that it is an ideal. Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

The processor circuitry described herein may include one or more microprocessors, microcontrollers, analog to digital converters, digital signal processing (DSP) elements, application-specific integrated circuits (ASICs), and/or field programmable gate arrays (FPGAs). In this exemplary embodiment, processor circuitry includes or functions with software programs, firmware, or other computer readable instructions for carrying out various process tasks, calculations, and control functions, used in the methods described herein. These instructions are typically tangibly embodied on any storage media (or computer readable medium) used for storage of computer readable instructions or data structures.

The memory circuitry described herein can be implemented with any available storage media (or computer readable medium) that can be accessed by a general purpose or special purpose computer or processor, or any programmable logic device. Suitable computer readable medium may include storage or memory media such as semiconductor, magnetic, and/or optical media. For example, computer readable media may include conventional hard disks, solid state drives, Compact Disk —Read Only Memory (CD-ROM), DVDs, volatile or non-volatile media such as Random Access Memory (RAM) (including, but not limited to, Dynamic Random Access Memory (DRAM)), Read Only Memory (ROM), Electrically Erasable Programmable ROM (EEPROM), SD cards or micro SD cards and/or flash memory. Combinations of the above are also included within the scope of computer readable media.

Methods of the invention can be implemented in computer readable instructions, such as program modules or applications, which may be stored in the computer readable medium that is part of (optionally the memory circuitry) or communicatively coupled to the processing circuitry, and executed by the processing circuitry, optionally the processor circuitry. Generally, program modules or applications include routines, programs, objects, data components, data structures, algorithms, and the like, which perform particular tasks or implement particular abstract data types.

### Example Embodiments

Example 1 includes an optical air data system (OADS) with improved sensitivity, the OADS comprising: a pulsed laser configured to emit an optical signal including pulses; an optical emitter optically coupled to the pulsed laser, and using the optical signal including pulses, configured to emit only one transmit optical beam along a transmit line of sight to a region of atmosphere; at least two optical receivers, wherein each of the at least two optical receivers is configured to receive a different return optical signal which is a reflected and/or scattered from the region of atmosphere along a unique receive line of sight; a rotatable platform configured to rotate around a first axis and to rotate around a second axis that is orthogonal to the first axis, wherein the optical emitter and each optical receiver are mounted on the rotatable platform, and wherein the rotatable platform is further configured to direct the transmit line of sight to the region of atmosphere; an optical processing circuitry including at least one optical sensor and configured to convert each of at least two return optical signals in to at least one electrical signal representative of at least one characteristic of one or more return optical signals; and electrical processing circuitry configured to receive the at least one electrical signal from the optical processing circuitry and, using the at least one electrical signal, generate at least one air data parameter about the region of atmosphere.

Example 2 includes the OADS of Example 1, wherein each optical receiver comprises one or more optical mirrors configured to reflect a return optical signal, one or more optical filters configured to optically filter the return optical signal, and/or one or more optical lenses configured to focus and/or collimate the return optical signal.

Example 3 includes the OADS of any of Examples 1-2, wherein the optical processing circuitry includes one or more optical signal processor and one or more optical sensors, wherein each optical signal processor is optically coupled to an optical sensor, and wherein each optical sensor is configured to convert each optical signal incident upon the optical sensor into an electrical signal.

Example 4 includes the OADS of Example 3, wherein each optical signal processor includes an interferometer, one or more optical filters, and/or an optical spectrograph.

Example 5 includes the OADS of any of Examples 1-4, wherein the at least two optical receivers include a first optical receiver including a first optical lens or mirror with a first diameter and a second optical receiver including a second optical lens or mirror with a second diameter, wherein the first diameter is less than the second diameter.

Example 6 includes the OADS of any of Examples 1-5, wherein the only one transmit optical beam is emitted by the optical emitter through a receive optical window of one of the at least two optical receivers.

Example 7 includes the OADS of any of Examples 1-6, wherein the at least one air data parameter comprises atmospheric pressure in the region of atmosphere, temperature in the region of atmosphere, humidity in the region of atmosphere, wind speed and/or wind direction in the region of atmosphere, quantifying a presence and characteristics of aerosols in the region of atmosphere, characterizing an effect of fluid motion on light in the region of atmosphere, and/or detecting and measuring a composition and/or a concentration of gases in the region of atmosphere.

Example 8 includes the OADS of any of Examples 1-7, wherein the rotatable platform is further configured to change an azimuthal angle and an elevation angle of the transmit line of sight.

Example 9 includes a method for improving sensitivity of an optical air data system, the method comprising: orienting a transmit line of sight towards a region of atmosphere; receiving an optical signal including pulses; emitting only one transmit optical beam, including pulses, along the transmit line of sight to the region of atmosphere; receiving at least two different return optical signals, wherein each return optical signal is received along a unique receive line of sight, wherein each return optical signal is derived by scattering and/or reflection, of the only one transmit optical beam, from the region of atmosphere; converting each of the at least two different return optical signals into at least one electrical signal representative of at least one characteristic of one or more return optical signals; and using the at least one electrical signal, generating data about one or more air data parameters about the region of atmosphere.

Example 10 includes the method of Example 9, wherein each return optical signal is reflected, optically filtered, collimated and/or focused.

Example 11 includes the method of any of Examples 9-10, further comprising filtering the at least one electrical signal.

Example 12 includes the method of any of Examples 9-11, wherein orienting the transmit line of sight towards the region of atmosphere comprises changing an azimuthal angle and an elevation angle of the transmit line of sight.

Example 13 includes the method of any of Examples 9-12, wherein the at least one air data parameter comprises atmospheric pressure in the region of atmosphere, temperature in the region of atmosphere, humidity in the region of atmosphere, wind speed and/or wind direction in the region of atmosphere, quantifying a presence and characteristics of aerosols in the region of atmosphere, characterizing an effect of fluid motion on light in the region of atmosphere, and/or detecting and measuring a composition and/or a concentration of gases in the region of atmosphere.

Example 14 includes an apparatus for improving sensitivity of an optical air data system (OADS), the apparatus comprising: an optical emitter optically coupled to a pulsed laser, and using an optical signal including pulses, configured to emit only one transmit optical beam along a transmit line of sight to a region of atmosphere; at least two optical receivers, wherein each of the at least two optical receivers is configured to receive a different return optical signal which is a reflected and/or scattered from the region of atmosphere along a unique receive line of sight; wherein the optical emitter and each optical receiver are mounted on a rotatable platform configured to rotate around a first axis and to rotate around a second axis that is orthogonal to the first axis so as to direct the transmit line of sight to the region of atmosphere; an optical processing circuitry including at least one optical sensor and configured to convert each of at least two return optical signals in to at least one electrical signal representative of at least one characteristic of one or more return optical signals; and electrical processing circuitry configured to receive the at least one electrical signal from the optical processing circuitry and, using the at least one electrical signal, generate at least one air data parameter about the region of atmosphere.

Example 15 includes the apparatus of Example 14, wherein each optical receiver comprises one or more optical mirrors configured to reflect a return optical signal, one or more optical filters configured to optically filter the return optical signal, and/or one or more optical lenses configured to focus and/or collimate the return optical signal.

Example 16 includes the apparatus of any of Examples 14-15, wherein the optical processing circuitry comprises one or more mirrors configured to reflect each return optical signal, one or more optical filters configured to optically filter each return optical signal, and/or one or more optical lenses configured to focus and/or collimate each return optical signal.

Example 17 includes the apparatus of any of Examples 14-16, wherein the at least two optical receivers include a first optical receiver including a first optical lens or mirror with a first diameter and a second optical receiver including a second optical lens or mirror with a second diameter, wherein the first diameter is less than the second diameter.

Example 18 includes the apparatus of any of Examples 14-17, wherein the only one transmit optical beam is emitted by the optical emitter through a receive optical window of one of the at least two optical receivers.

Example 19 includes the apparatus of any of Examples 14-18, wherein the optical processing circuitry includes one or more optical signal processor circuits and one or more optical sensors, wherein each optical signal processor circuit is optically coupled to an optical sensor, and wherein each optical sensor is configured to convert each optical signal incident upon the optical sensor into an electrical signal.

Example 20 includes the apparatus of any of Examples 14-19, wherein the at least one air data parameter comprises atmospheric pressure in the region of atmosphere, temperature in the region of atmosphere, humidity in the region of atmosphere, wind speed and/or wind direction in the region of atmosphere, quantifying a presence and characteristics of aerosols in the region of atmosphere, characterizing an effect of fluid motion on light in the region of atmosphere, and/or detecting and measuring a composition and/or a concentration of gases in the region of atmosphere.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. An optical air data system (OADS) with improved sensitivity, the OADS comprising:
a pulsed laser configured to emit an optical signal including pulses;
an optical emitter optically coupled to the pulsed laser, and using the optical signal including pulses, configured to emit only one transmit optical beam along a transmit line of sight to a region of atmosphere;
at least two optical receivers, wherein each of the at least two optical receivers is configured to receive a different return optical signal which is a reflected and/or scattered from the region of atmosphere along a unique receive line of sight;
a rotatable platform configured to rotate around a first axis and to rotate around a second axis that is orthogonal to the first axis, wherein the optical emitter and each optical receiver are mounted on the rotatable platform, and wherein the rotatable platform is further configured to direct the transmit line of sight to the region of atmosphere;
an optical processing circuitry including at least one optical sensor and configured to convert each of at least two return optical signals in to at least one electrical signal representative of at least one characteristic of one or more return optical signals; and
electrical processing circuitry configured to receive the at least one electrical signal from the optical processing circuitry and, using the at least one electrical signal, generate at least one air data parameter about the region of atmosphere.

2. The OADS of claim 1, wherein each optical receiver comprises one or more optical mirrors configured to reflect a return optical signal, one or more optical filters configured to optically filter the return optical signal, and/or one or more optical lenses configured to focus and/or collimate the return optical signal.

3. The OADS of claim 1, wherein the optical processing circuitry includes one or more optical signal processor and one or more optical sensors, wherein each optical signal processor is optically coupled to an optical sensor, and wherein each optical sensor is configured to convert each optical signal incident upon the optical sensor into an electrical signal.

4. The OADS of claim 3, wherein each optical signal processor includes an interferometer, one or more optical filters, and/or an optical spectrograph.

5. The OADS of claim 1, wherein the at least two optical receivers include a first optical receiver including a first optical lens or mirror with a first diameter and a second optical receiver including a second optical lens or mirror with a second diameter, wherein the first diameter is less than the second diameter.

6. The OADS of claim 1, wherein the only one transmit optical beam is emitted by the optical emitter through a receive optical window of one of the at least two optical receivers.

7. The OADS of claim 1, wherein the at least one air data parameter comprises atmospheric pressure in the region of atmosphere, temperature in the region of atmosphere, humidity in the region of atmosphere, wind speed and/or wind direction in the region of atmosphere, quantifying a presence and characteristics of aerosols in the region of atmosphere, characterizing an effect of fluid motion on light in the region of atmosphere, and/or detecting and measuring a composition and/or a concentration of gases in the region of atmosphere.

8. The OADS of claim 1, wherein the rotatable platform is further configured to change an azimuthal angle and an elevation angle of the transmit line of sight.

9. A method for improving sensitivity of an optical air data system, the method comprising:
orienting a transmit line of sight towards a region of atmosphere;
receiving an optical signal including pulses;
emitting only one transmit optical beam, including pulses, along the transmit line of sight to the region of atmosphere;
receiving at least two different return optical signals, wherein each return optical signal is received along a unique receive line of sight, wherein each return optical signal is derived by scattering and/or reflection, of the only one transmit optical beam, from the region of atmosphere;
converting each of the at least two different return optical signals into at least one electrical signal representative of at least one characteristic of one or more return optical signals; and
using the at least one electrical signal, generating data about one or more air data parameters about the region of atmosphere.

10. The method of claim 9, wherein each return optical signal is reflected, optically filtered, collimated and/or focused.

11. The method of claim 9, further comprising filtering the at least one electrical signal.

12. The method of claim 9, wherein orienting the transmit line of sight towards the region of atmosphere comprises changing an azimuthal angle and an elevation angle of the transmit line of sight.

13. The method of claim 9, wherein the at least one air data parameter comprises atmospheric pressure in the region of atmosphere, temperature in the region of atmosphere, humidity in the region of atmosphere, wind speed and/or wind direction in the region of atmosphere, quantifying a presence and characteristics of aerosols in the region of atmosphere, characterizing an effect of fluid motion on light in the region of atmosphere, and/or detecting and measuring a composition and/or a concentration of gases in the region of atmosphere.

14. An apparatus for improving sensitivity of an optical air data system (OADS), the apparatus comprising:
an optical emitter optically coupled to a pulsed laser, and using an optical signal including pulses, configured to emit only one transmit optical beam along a transmit line of sight to a region of atmosphere;
at least two optical receivers, wherein each of the at least two optical receivers is configured to receive a different return optical signal which is a reflected and/or scattered from the region of atmosphere along a unique receive line of sight;
wherein the optical emitter and each optical receiver are mounted on a rotatable platform configured to rotate around a first axis and to rotate around a second axis that is orthogonal to the first axis so as to direct the transmit line of sight to the region of atmosphere;
an optical processing circuitry including at least one optical sensor and configured to convert each of at least two return optical signals in to at least one electrical signal representative of at least one characteristic of one or more return optical signals; and
electrical processing circuitry configured to receive the at least one electrical signal from the optical processing circuitry and, using the at least one electrical signal, generate at least one air data parameter about the region of atmosphere.

15. The apparatus of claim 14, wherein each optical receiver comprises one or more optical mirrors configured to reflect a return optical signal, one or more optical filters configured to optically filter the return optical signal, and/or one or more optical lenses configured to focus and/or collimate the return optical signal.

16. The apparatus of claim 14, wherein the optical processing circuitry comprises one or more mirrors configured to reflect each return optical signal, one or more optical filters configured to optically filter each return optical signal, and/or one or more optical lenses configured to focus and/or collimate each return optical signal.

17. The apparatus of claim 14, wherein the at least two optical receivers include a first optical receiver including a first optical lens or mirror with a first diameter and a second optical receiver including a second optical lens or mirror with a second diameter, wherein the first diameter is less than the second diameter.

18. The apparatus of claim 14, wherein the only one transmit optical beam is emitted by the optical emitter through a receive optical window of one of the at least two optical receivers.

19. The apparatus of claim 14, wherein the optical processing circuitry includes one or more optical signal processor circuits and one or more optical sensors, wherein each optical signal processor circuit is optically coupled to an optical sensor, and wherein each optical sensor is configured to convert each optical signal incident upon the optical sensor into an electrical signal.

20. The apparatus of claim 14, wherein the at least one air data parameter comprises atmospheric pressure in the region of atmosphere, temperature in the region of atmosphere, humidity in the region of atmosphere, wind speed and/or wind direction in the region of atmosphere, quantifying a presence and characteristics of aerosols in the region of atmosphere, characterizing an effect of fluid motion on light in the region of atmosphere, and/or detecting and measuring a composition and/or a concentration of gases in the region of atmosphere.
